(19) United States
(12) Patent Application Publication
(10) Pub. No.: US 2025/0357049 A1
(43) Pub. Date: Nov. 20, 2025

(54) CERAMIC ELECTRONIC COMPONENT AND METHOD OF MANUFACTURING THE SAME

(71) Applicant: TAIYO YUDEN CO., LTD., Tokyo (JP)

(72) Inventors: Ayumi SHIROTA, Takasaki-shi (JP); Ayumi MATSUOKA, Takasaki-shi (JP)

(21) Appl. No.: 19/283,939

(22) Filed: Jul. 29, 2025

Related U.S. Application Data
(63) Continuation of application No. PCT/JP2024/005224, filed on Feb. 15, 2024.

(30) Foreign Application Priority Data
Feb. 20, 2023 (JP) 2023-024470

(51) Int. Cl. H01G 4/30; H01G 4/008

(52) U.S. Cl. CPC H01G 4/30; H01G 4/0085

(57) ABSTRACT

A ceramic electronic component includes a multilayer chip including a plurality of dielectric layers and a plurality of internal electrode layers including metal as a main component. A stacking number of internal electrode layers per unit height in a section where adjacent internal electrode layers connected to different external electrodes face each other is 700 layers/mm or more, and a metal component having a melting point of 700° C. or less is provided at least one of inside a first internal electrode layer disposed in a central portion of the multilayer chip in a third direction in the plurality of internal electrode layers, inside a first dielectric layer disposed in the central portion in the plurality of dielectric layers, or at an interface between the first internal electrode layer and the first dielectric layer.

### CROSS-REFERENCE TO RELATED APPLICATION

This application is based upon and claims the benefit of priority of the prior International Patent Application No. PCT/JP2024/005224, filed on Feb. 15, 2024, which claims the benefits of priorities of Japanese Patent Application No. 2023-024470 filed on Feb. 20, 2023, the entire contents of which are incorporated herein by reference.

### FIELD

A certain aspect of the present disclosure relates to a ceramic electronic component and a method of manufacturing the same.

### BACKGROUND

In recent years, electronic devices such as portable information terminals have been reduced in size, and the mounting area of each of ceramic electronic components on a circuit board has been limited. On the other hand, as the functionality of devices increases, there is a demand for further increasing the capacitance of multilayer ceramic capacitors.

### SUMMARY OF THE INVENTION

According to a first aspect of the present disclosure, there is provided a ceramic electronic component having a dimension in a first direction, a dimension in a second direction orthogonal to the first direction, and a dimension in a third direction orthogonal to the first direction and the second direction that are all 1 mm or greater, the ceramic electronic component including: a multilayer chip including a plurality of dielectric layers and a plurality of internal electrode layers including metal as a main component, the plurality of dielectric layers and the plurality of internal electrode layers being alternately stacked in the third direction, the multilayer chip having a substantially rectangular parallelepiped shape and being formed so that the plurality of internal electrode layers are alternately exposed on a first end surface and a second end surface facing each other in the second direction, wherein a stacking number of internal electrode layers per unit height in a section where adjacent internal electrode layers connected to different external electrodes face each other is 700 layers/mm or greater, and a metal component having a melting point of 700° C. or less is provided in at least one of the following locations: inside at least a first internal electrode layer disposed in a central portion of the multilayer chip in the third direction in the plurality of internal electrode layers, inside at least a first dielectric layer disposed in the central portion in the plurality of dielectric layers, and at an interface between the first internal electrode layer and the first dielectric layer.

According to a second aspect of the present disclosure, there is provided a method of manufacturing a ceramic electronic component, the ceramic electronic component having a dimension in a first direction, a dimension in a second direction orthogonal to the first direction, and a dimension in a third direction orthogonal to the first direction and the second direction that are all 1 mm or more. The method includes: stacking a plurality of first multilayer units in the third direction to obtain a first multilayer body, each of the first multilayer units including a first dielectric green sheet and a first internal electrode pattern formed on the first dielectric green sheet; stacking a plurality of second multilayer units on the first multilayer body to obtain a second multilayer body, each of the second multilayer units including a second dielectric green sheet and a second internal electrode pattern formed on the second dielectric green sheet; stacking a plurality of first multilayer units on the second multilayer body to obtain a third multilayer body; and firing the third multilayer body; wherein a stacking number of the first internal electrode pattern and the second internal electrode pattern per unit height of the third multilayer body is 700 layers/mm or greater, and a metal component having a melting point of 700° C. or less is added to at least the second dielectric green sheet or at least the second internal electrode pattern.

### BRIEF DESCRIPTION OF THE DRAWINGS

FIG. 1A is a partial cross-sectional perspective view of a multilayer ceramic capacitor according to a first embodiment, and FIG. 1B is a plan view of the multilayer ceramic capacitor.

FIG. 2A is a cross-sectional view taken along line A-A of FIG. 1B, and FIG. 2B is a cross-sectional view taken along line B-B of FIG. 1B.

FIG. 3 is an enlarged cross-sectional view of the vicinity of an external electrode.

FIG. 4 is a diagram illustrating debinder cracks.

FIG. 5 is a flowchart illustrating a method of manufacturing a multilayer ceramic capacitor.

FIG. 6 is a diagram illustrating an overview of a method of manufacturing the multilayer ceramic capacitor according to the first embodiment.

FIG. 7 is a cross-sectional view of a multilayer ceramic capacitor according to a second embodiment.

FIG. 8 is a diagram illustrating an overview of a method of manufacturing the multilayer ceramic capacitor according to the second embodiment.

FIG. 9 is a cross-sectional view of a multilayer ceramic capacitor according to a third embodiment.

FIG. 10 is a diagram illustrating an overview of a method of manufacturing the multilayer ceramic capacitor according to the third embodiment.

FIG. 11 is a cross-sectional view of a multilayer ceramic capacitor according to a fourth embodiment.

FIG. 12 is a diagram illustrating an overview of a method of manufacturing the multilayer ceramic capacitor according to the fourth embodiment.

FIG. 13 is a cross-sectional view of a multilayer ceramic capacitor according to a fifth embodiment.

FIG. 14 is a diagram illustrating an overview of a method of manufacturing the multilayer ceramic capacitor according to the fifth embodiment.

FIG. 15 is a diagram illustrating cracks.

FIGS. 16A and 16B are cross-sectional views of a multilayer ceramic capacitor according to a sixth embodiment.

FIG. 17 is a diagram illustrating an overview of a method of manufacturing the multilayer ceramic capacitor according to the sixth embodiment.

### DETAILED DESCRIPTION

In order to realize a large capacity of a multilayer ceramic capacitor, it is important to reduce the thicknesses of dielectric layers and internal electrode layers and increase the number of stacked layers. However, when the dielectric layers and the internal electrode layers are thinned and the number of stacked layers is increased, the binder may not be sufficiently removed (for example, see Japanese Laid-Open Patent Publication No. 2011-134943). When a debinding property is not favorable, the continuity of the internal electrode layer deteriorates in the central portion of the multilayer chip (for example, see Japanese Laid-Open Patent Publication No. 2013-211357).

In view of such circumstances, an object of this disclosure is to provide a ceramic electronic component and a method for manufacturing the same capable of realizing a favorable debinding property.

Hereinafter, embodiments will be described with reference to the drawings.

### First Embodiment

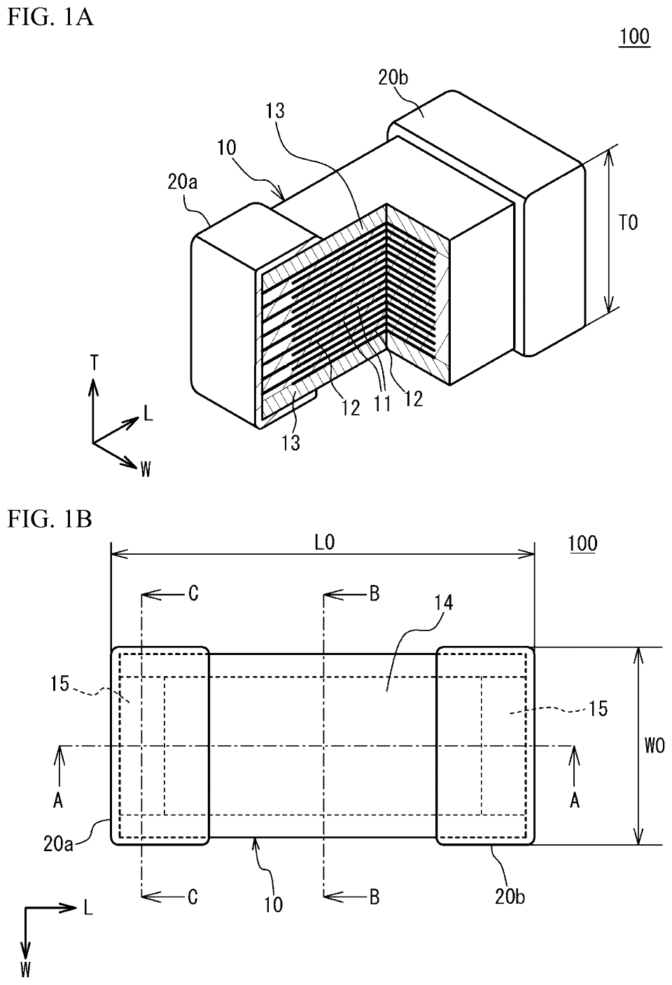

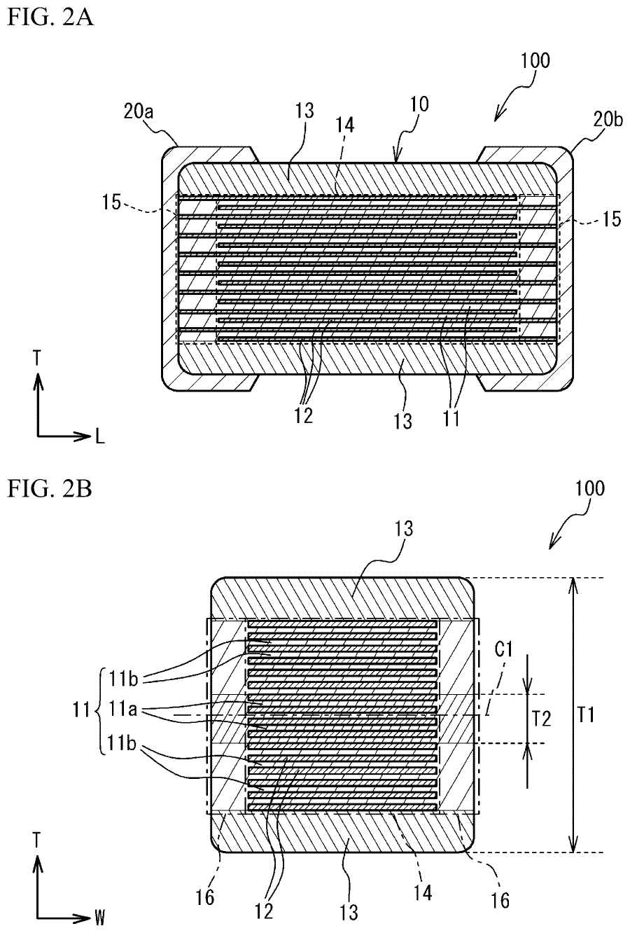

FIG. 1A is a partial cross-sectional perspective view of a multilayer ceramic capacitor 100 according to a first embodiment, and FIG. 1B is a plan view of the multilayer ceramic capacitor 100. FIG. 2A is a cross-sectional view taken along line A-A of FIG. 1B, and FIG. 2B is a cross-sectional view taken along line B-B of FIG. 1B.

As illustrated in FIGS. 1A to 2B, the multilayer ceramic capacitor 100 includes a multilayer chip 10 having a substantially rectangular parallelepiped shape, and external electrodes 20a and 20b provided on two end surfaces of the multilayer chip 10 facing each other. Among four surfaces of the multilayer chip 10 other than the two end surfaces, two surfaces other than an upper surface and a lower surface of the multilayer chip 10 in the stacking direction are referred to as side surfaces. The external electrodes 20a and 20b extend on the upper surface, the lower surface, and the two side surfaces of the multilayer chip 10. However, the external electrodes 20a and 20b are separated from each other.

In FIGS. 1A to 2B, an L direction (first direction) is a length direction of the multilayer chip 10, a direction in which two end surfaces of the multilayer chip 10 face each other, and a direction in which the external electrode 20a and the external electrode 20b face each other. A W direction (second direction) is a width direction of the multilayer chip 10, and is a direction in which two side surfaces of the multilayer chip 10 face each other. In addition, a T direction (third direction) is a stacking direction of dielectric layers 11 and internal electrode layers 12, and is a direction in which the upper surface and the lower surface of the multilayer chip 10 face each other. The L direction, the W direction, and the T direction are orthogonal to each other.

The multilayer chip 10 has a configuration in which the dielectric layers 11 containing a ceramic material functioning as a dielectric and the internal electrode layers 12 containing a metal as a main component are alternately stacked. In other words, the multilayer chip 10 includes a plurality of internal electrode layers 12 facing each other and the dielectric layers 11 each interposed between the plurality of internal electrode layers 12. The edges of the internal electrode layers 12 in the extending direction are alternately exposed to a first end surface on which the external electrode 20a of the multilayer chip 10 is provided and a second end surface on which the external electrode 20b is provided. The internal electrode layers 12 connected to the external electrode 20a are not connected to the external electrode 20b. The internal electrode layers 12 connected to the external electrode 20b are not connected to the external electrode 20a. Therefore, each of the internal electrode layers 12 is electrically connected to the external electrode 20a and the external electrode 20b alternately. In the multilayer body of the dielectric layers 11 and the internal electrode layers 12, the internal electrode layer 12 is disposed at an uppermost layer in the stacking direction, the internal electrode layer 12 is also disposed at a lowermost layer in the stacking direction, and the upper surface and the lower surface of the multilayer body are covered with cover layers 13. The cover layers 13 are composed of a ceramic material as a main component. For example, the main component of the cover layers 13 is the same as the main component of the dielectric layers 11.

The dielectric layer 11 has, for example, a ceramic material having a perovskite structure represented by a general formula ABO₃ as a main phase. The perovskite structure contains ABO_{3-α} that deviates from the stoichiometric composition. For example, as the ceramic material, at least one of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming the perovskite structure can be selected and used. Ba_{1-x-y}CaₓSr_{y}Ti_{1-z}Zr_{z}O₃ is barium strontium titanate, barium calcium titanate, barium zirconate, barium zirconate titanate, calcium zirconate titanate, barium calcium zirconate titanate, and the like.

An additive may be added to the dielectric layer 11. Examples of the additive to the dielectric layer 11 include magnesium (Mg), manganese (Mn), molybdenum (Mo), vanadium (V), chromium (Cr), oxides of rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)), oxides containing cobalt (Co), nickel (Ni), lithium (Li), boron (B), sodium (Na), potassium (K), or silicon (Si), or glass containing Co, Ni, Li, B, Na, K, or Si.

The thickness of each dielectric layer 11 in the T direction is, for example, 0.3 μm or more and 3 μm or less. The thickness of each dielectric layer 11 in the T direction can be measured by exposing the cross section of the multilayer ceramic capacitor 100 illustrated in FIG. 2A by mechanical polishing, and then obtaining an average value of the thicknesses at 10 positions from an image taken by a microscope such as a scanning transmission electron microscope.

The internal electrode layer 12 contains Ni as a main component. The thickness of each internal electrode layer 12 in the T direction is, for example, 0.1 μm or more and 2 μm or less. The thickness of each internal electrode layer 12 in the T direction can be measured by exposing the cross section of the multilayer ceramic capacitor 100 illustrated in FIG. 2A by mechanical polishing, and then calculating an average value of the thicknesses at 10 positions from an image taken by a microscope such as a scanning transmission electron microscope.

As illustrated in FIG. 2A, a section in which the internal electrode layers 12 connected to the external electrode 20a and the internal electrode layers 12 connected to the external electrode 20b face each other is a section in which an electrostatic capacitance is generated in the multilayer ceramic capacitor 100. Therefore, the section where the electrostatic capacitance is generated is referred to as a capacitance portion 14. That is, the capacitance portion 14 is a section in which adjacent internal electrode layers connected to different external electrodes face each other.

A section in which the internal electrode layers 12 connected to the external electrode 20a face each other without the internal electrode layers 12 connected to the external electrode 20b interposed therebetween is referred to as an end margin 15. A section where the internal electrode layers 12 connected to the external electrode 20b face each other without the internal electrode layers 12 connected to the external electrode 20a interposed therebetween is also referred to as the end margin 15. That is, the end margins 15 are sections in which the internal electrode layers connected to the same external electrode face each other without the internal electrode layers connected to different external electrode interposed therebetween. The end margins 15 are sections where no electrostatic capacitance is generated. The end margins 15 may have the same composition as or may have a different composition from the dielectric layers 11 of the capacitance portion 14.

As illustrated in FIG. 2B, in the multilayer chip 10, sections from respective side surface to the internal electrode layers 12 in the W direction are referred to as side margins 16. That is, the side margins 16 are sections provided so as to cover the end portions extending to the respective side surfaces of the plurality of internal electrode layers 12 stacked in the above-mentioned multilayer structure. The side margins 16 are also sections where no electrostatic capacitance is generated. The side margins 16 may have the same composition as or may have a different composition from the dielectric layers 11 of the capacitance portion 14.

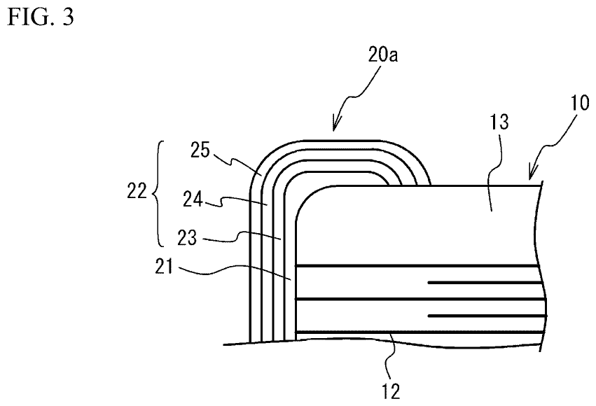

FIG. 3 is an enlarged cross-sectional view of the vicinity of the external electrode 20a. In FIG. 3, hatching is omitted. As illustrated in FIG. 3, the external electrode 20a has a structure in which a plating layer 22 is provided on a base layer 21. The base layer 21 contains Cu as a main component. The base layer 21 may contain a glass component. The plating layer 22 contains a metal such as Ni, aluminum (Al), zinc (Zn), or Sn, or an alloy of two or more of these metals as a main component. The plating layer 22 may be a plating layer containing a single metal component, or may be a plurality of plating layers containing different metal components. For example, the plating layer 22 has a structure in which a first plating layer 23, a second plating layer 24, and a third plating layer 25 are formed in a closer order from the base layer 21. The first plating layer 23 is, for example, an Sn plating layer. The second plating layer 24 is, for example, an Ni plating layer. The third plating layer 25 is, for example, an Sn plating layer. Although FIG. 3 illustrates the external electrode 20a, the external electrode 20b also have the same multilayer structure.

In order to realize a multilayer ceramic capacitor having a large capacitance, it is important to reduce the thicknesses of the dielectric layers and the internal electrode layers and increase the stacking number of layers. Therefore, the multilayer ceramic capacitor 100 according to the present embodiment has a configuration in which the stacking number of internal electrode layers is increased. Specifically, as illustrated in FIGS. 1A and 1B, when the height of the multilayer ceramic capacitor 100 in the T direction is defined as a height T0, the width in the W direction is defined as a width W0, and the length in the L direction is defined as a length L0, the multilayer ceramic capacitor 100 has the T0, the W0, and the L0 that are all equal to or greater than 1 mm, and the stacking number of internal electrode layers 12 per unit height in the capacitance portion 14 (a stacking density of the internal electrode layers 12) is 700 layers/mm or more. The height T0, the width W0, and the length L0 are maximum dimensions of the multilayer ceramic capacitor 100 in the T direction, the W direction, and the L direction, respectively.

The size of the multilayer ceramic capacitor 100 is, for example, length (L0) 3.2 mm, width (W0) 1.6 mm, and height (T0) 1.6 mm, or length (L0) 3.2 mm, width (W0) 2.5 mm, and height (T0) 2.5 mm, or length (L0) 4.5 mm, width (W0) 3.2 mm, and height (T0) 2.5 mm, or length (L0) 5.7 mm, width (W0) 5.0 mm, and height (T0) 2.5 mm, but is not limited to these sizes.

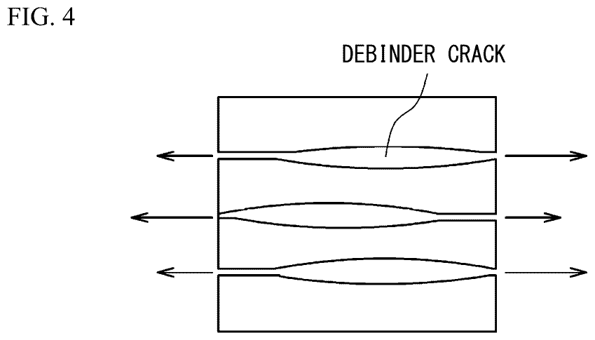

However, when the stacking number of internal electrode layers 12 is large, even if a debinding step of removing the organic binder contained in the multilayer body before firing is performed, the binder may not be sufficiently removed because the discharge path of the binder is long. In this case, as illustrated in FIG. 4, the decomposition gas of the binder remains inside the multilayer body, and cracks (debinder cracks) or delamination may occur.

Therefore, the multilayer ceramic capacitor 100 according to the present embodiment has a configuration in which the T0, the W0, and the L0 are all equal to or higher than the 1 mm, and the favorable debinding property can be achieved even in a configuration in which the stacking density of the internal electrode layers 12 in the capacitance portion 14 is 700 layers/mm or more.

Specifically, a metal component having a melting point of 700° C. or less (hereinafter referred to as a low melting point metal) is provided inside the dielectric layers 11 at least in the central portion of the multilayer chip 10 in the T direction. More specifically, the low melting point metal has a melting point within a range of a heat treatment temperature (about 200° C. to 700° C.) in the debinding step. Hereinafter, the dielectric layers 11 including the low melting point metal are referred to as first dielectric layers 11a, and the dielectric layers 11 including no low melting point metal are referred to as second dielectric layers 11b. That is, the dielectric layers 11 includes the first dielectric layers 11a and the second dielectric layers 11b.

The low melting point metal is not particularly limited as long as it has a melting point within the range of the heat treatment temperature (about 200° C. to 700° C.) in the debinding step, and examples thereof include tin (Sn, melting point 231.97° C.), bismuth (Bi, melting point 271.4° C.), cadmium (Cd, melting point 321.03° C.), lead (Pb, melting point 327.5° C.), zinc (Zn, melting point 419.6° C.), antimony (Sb, melting point 630.7° C.), and aluminum (Al, melting point 660° C.).

As illustrated in FIG. 2B, the central portion of the multilayer chip 10 in the T direction includes a center line C1 that bisects the multilayer chip 10 in the T direction, and indicates a portion where the height T1 in the T direction is 25% to 75% when the height T2 in the T direction of the multilayer chip 10 is 100%. The central portion is substantially symmetrical with respect to the center line C1.

Since the low melting point metal is provided inside the dielectric layers 11 at least in the central portion of the multilayer chip 10 in the T direction, the decomposition of the binder is promoted and the release of the decomposition gas is improved during the heat treatment in the debinding step, as compared with the case where the low melting point metal is not provided. This realizes the favorable debinding property, and suppresses the cracks and the delamination.

If a sufficient amount of the low melting point metal is not added, there is a possibility that the sufficiently favorable debinding property cannot be obtained. Therefore, it is preferable to set a lower limit to the concentration of the low melting point metal. In the present embodiment, the concentration of the low-melting point metal is preferably 0.1 at % or more, more preferably 0.3 at % or more, and further preferably 0.5 at % or more. The concentration of the low melting point metal is an amount (at %) of the low melting point metal in the entire dielectric layer 11 sandwiched between two adjacent internal electrode layers 12, when a B-site element of the dielectric layer 11 is represented by 100 at %. When a plurality of types of low melting point metals are contained, the concentration of the low melting point metals is a total amount of the plurality of types of low melting point metals.

On the other hand, when the additive amount of the low melting point metal is large, the internal electrode may be spheroidized due to oversintering or abnormal grain growth of the dielectric layer may occur. Therefore, it is preferable to set an upper limit to the concentration of the low melting point metal. In the present embodiment, the concentration of the low melting point metal is preferably 10 at % or less, more preferably 5 at % or less, and further preferably 2 at % or less.

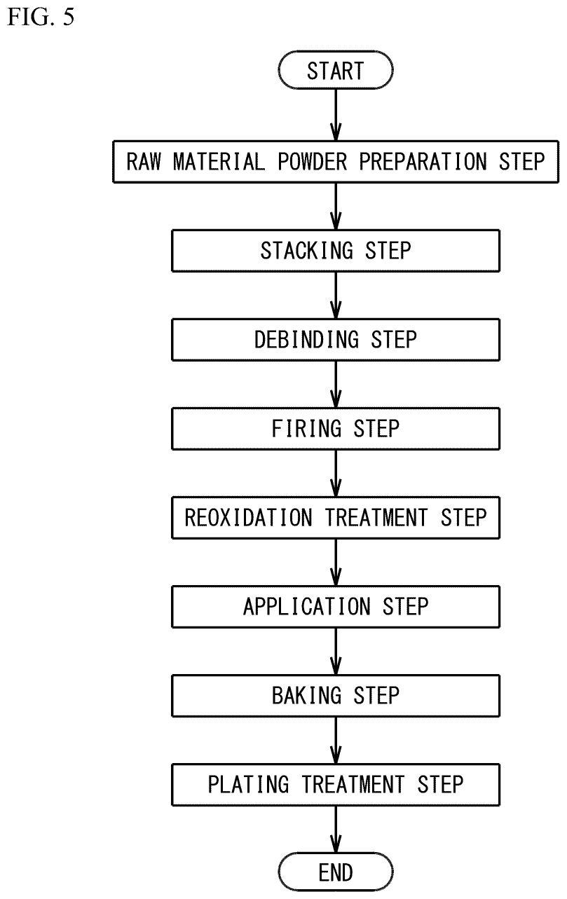

Next, a method of manufacturing the multilayer ceramic capacitor 100 according to the first embodiment will be described. FIG. 5 is a flowchart illustrating a method of manufacturing the multilayer ceramic capacitor 100.

### Raw Material Powder Preparation Step

First, a first dielectric material for forming the first dielectric layers 11a is prepared. An A-site element and the B-site element contained in the first dielectric layers 11a are usually in the form of sintered bodies of ABO₃ particles. For example, BaTiO₃ is a tetragonal compound having a perovskite structure and indicates a high dielectric constant. The BaTiO₃ can be generally obtained by reacting a titanium material such as titanium dioxide with a barium material such as barium carbonate to synthesize barium titanate. As a method of synthesizing the main component ceramic of the first dielectric layers 11a, various methods have been conventionally known, and for example, a solid-phase method, a sol-gel method, a hydro-thermal method, and the like have been known. In the present embodiment, any of these can be adopted.

The low melting point metal is added to the obtained ceramic powder. If a sufficient amount of the low-melting point metal is not added, there is a possibility that the sufficiently favorable debinding property cannot be obtained. Therefore, it is preferable to set a lower limit to the concentration of the low melting point metal. In the present embodiment, the concentration of the low melting point metal is preferably 0.1 at % or more, more preferably 0.3 at % or more, and further preferably 0.5 at % or more. The concentration of the low melting point metal is an amount (at %) of the low melting point metals when the B-site element is represented by 100 at %. When a plurality of types of low melting point metals are contained, the concentration of the low melting point metals is a total amount of the plurality of types of low melting point metals.

A predetermined additive compound may be added depending on the purpose. Examples of the additive compound include Mg, Mn, Mo, V, Cr, oxides of rare earth elements (Y, Sm, Eu, Gd, Tb, Dy, Ho, Er, Tm, and Yb), oxides containing Co, Ni, Li, B, Na, K, or Si, or glasses containing Co, Ni, Li, B, Na, K, or Si. Among these, SiO₂ mainly functions as a sinter aid.

For example, a compound containing the low melting metal and the additive compound is wet-mixed with ceramic raw material powders, and the mixture is dried and pulverized to prepare a ceramic material. For example, the ceramic material obtained as described above may be subjected to a pulverization treatment to adjust the particle size, or may be subjected to a combination with a classification treatment to adjust the particle size, as necessary. The first dielectric material is obtained by the above steps.

Next, a second dielectric material for forming the second dielectric layers 11b is prepared. The second dielectric material includes the same main component ceramic as the first dielectric layers 11a. As the main component ceramic, for example, BaTiO₃ powder is prepared. The BaTiO₃ powder can be prepared by the same procedure as that of the first dielectric material. The low melting point metal is not added to the obtained BaTiO₃ powder, but a predetermined additive compound is added according to the purpose. Examples of the additive compound include Zr, Ca, Sr, Mg, Mn, V, Cr, and oxides of rare earth elements, and oxides or glasses of Co, Ni, Li, B, Na, K, and Si.

### Stacking Step

Next, a binder such as PVB resin, an organic solvent such as ethanol or toluene, and a plasticizer are added to the obtained first dielectric material and wet-mixed. The obtained slurry is applied to a base material by, for example, a die-coater method or a doctor-blade method, and dried to obtain a first dielectric green sheet 51a. The base material is, for example, a PET film.

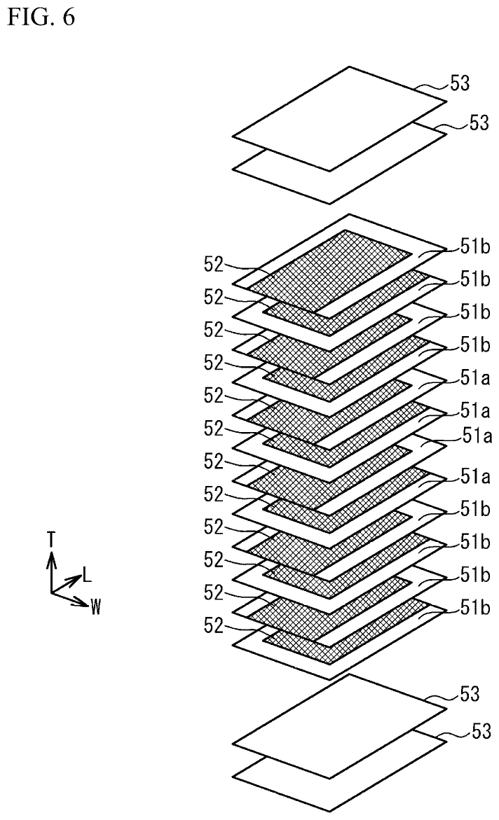

Next, as illustrated in FIG. 6, internal electrode patterns 52 are formed on the first dielectric green sheets 51a. The first dielectric green sheets 51a on which the internal electrode patterns 52 are formed are defined as first multilayer units. A metal paste containing Ni powder is used for the internal electrode patterns 52. The method of film formation may be printing, sputtering, vapor deposition, or the like.

Further, a binder such as polyvinyl butyral (PVB) resin, an organic solvent such as ethanol or toluene, and a plasticizer are added to the obtained second dielectric material and wet-mixed. The obtained slurry is applied to a base material by, for example, a die-coater method or a doctor-blade method, and dried to obtain second dielectric green sheets 51b. The base material is, for example, a polyethylene terephthalate (PET) film.

Next, as in the first multilayer units, the internal electrode patterns 52 are formed on the second dielectric green sheets 51b. The second dielectric green sheets 51b on which the internal electrode patterns 52 are formed are defined as second multilayer units.

Next, while the second dielectric green sheets 51b are peeled off from the base materials, a predetermined number of second multilayer units are stacked as illustrated in FIG. 6. While the first dielectric green sheets 51a are peeled off from the base materials, a predetermined number of first multilayer units are stacked on the predetermined number of second multilayer units as illustrated in FIG. 6, and a predetermined number of second multilayer units are stacked thereon again.

Next, a predetermined number (for example, 2 to 10) of cover sheets 53 are stacked on and under the multilayer body obtained by stacking the first multilayer unit and the second multilayer unit, and are thermally compressed. The cover sheets 53 can be formed by the same method as that for the second dielectric green sheets 51b.

### Debinding Step

The multilayer body thus obtained is subjected to a debinding treatment in an N₂ atmosphere. The heat treatment temperature is about 200° C. to 700° C., and the heat treatment time is about 5 minutes to 1 hour.

### Firing Step

Thereafter, the resultant is fired at 1100° C. to 1300° C. for 10 minutes to 2 hours in a reduction atmosphere with an oxygen partial pressure of 10⁻⁵ to 10⁻⁸ atm. In this manner, the multilayer chip 10 is obtained.

### Reoxidation Treatment Step

Thereafter, a reoxidation treatment may be performed at 600° C. to 1000° C. in an N₂ gas atmosphere.

### Application Step

Next, a metal paste to be the base layer 21 is applied to a first side surface of the multilayer body by a dipping method or the like. The metal paste contains a glass component such as glass frit.

### Baking Step

Next, the metal paste is baked at a temperature of about 700° C. to 900° C. to form the base layer 21.

### Plating Treatment Step

Thereafter, a metal coating of copper, nickel, tin, or the like may be formed on the base layer 21 by plating. For example, the first plating layer 23, the second plating layer 24, and the third plating layer 25 are formed in this order on the base layer 21. Thus, the multilayer ceramic capacitor 100 is completed.

According to the manufacturing method of the present embodiment, the low melting point metal is added to the first dielectric green sheets 51a disposed in the central portion of the multilayer chip 10 in the T direction. By adding the low melting point metal, the decomposition of the binder is promoted and the release of the decomposition gas is improved during the heat treatment in the debinding step, as compared with the case where the low melting point metal is not added. This realizes the favorable debinding property, and suppresses the cracks and the delamination.

In the above-described manufacturing method, the base layer 21 is baked after the multilayer chip 10 is fired, but the manufacturing method is not limited thereto. For example, the base layer 21 may be fired at the same time as the multilayer chip 10 is fired.

### Second Embodiment

In the first embodiment, the first dielectric layers 11a containing the low melting point metal extend from one of the two side surfaces of the multilayer chip 10 to the other, but may be provided only in a region corresponding to the capacitance portion 14 in the W direction.

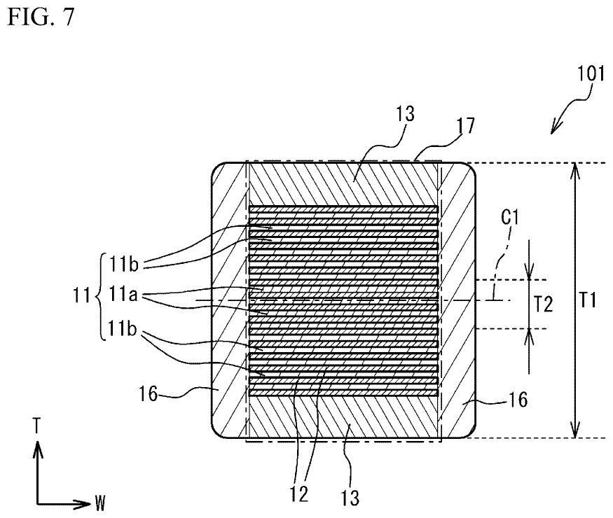

FIG. 7 is a cross-sectional view of a multilayer ceramic capacitor 101 according to a second embodiment. FIG. 7 illustrates a cross section at the same position as a cross section in FIG. 2B.

As illustrated in FIG. 7, in the multilayer ceramic capacitor 101, the side margins 16 are provided on both side surfaces in the W direction of a multilayer body 17 including the first dielectric layers 11a, the second dielectric layers 11b, the internal electrode layers 12, and the cover layers 13. The composition of the side margins 16 may be the same as or different from that of the cover layers 13. The other configurations are the same as those of the first embodiment, and thus the detailed description thereof will be omitted.

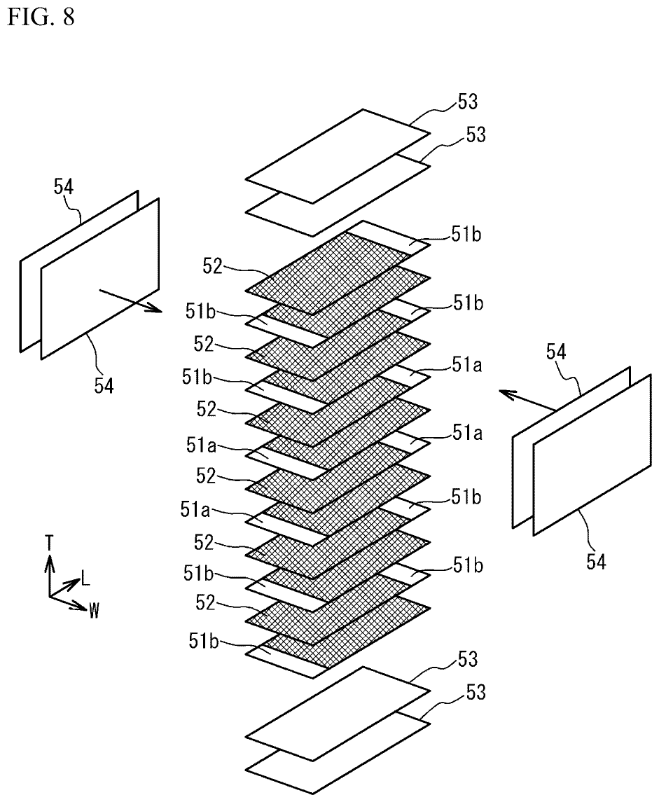

The multilayer ceramic capacitor 101 according to the second embodiment can be produced as illustrated in FIG. 8. First, the internal electrode patterns 52 are formed on the second dielectric green sheets 51b to form the second multilayer units. Next, the second multilayer units are sequentially stacked. The widths of the internal electrode patterns 52 in the W direction are made to coincide with the widths of the second dielectric green sheets 51b in the W direction. Next, the internal electrode patterns 52 are formed on the first dielectric green sheets 51a to form the first multilayer units. Next, the first multilayer units are sequentially stacked. The widths of the internal electrode patterns 52 in the W direction are made to coincide with the widths of the first dielectric green sheets 51a in the W direction. Next, the second multilayer units are sequentially stacked again. The predetermined number (for example, 2 to 10) of cover sheets 53 are stacked on and under the multilayer body obtained by stacking the multilayer units, and are thermally compressed. Next, a plurality of side margin sheets 54 are attached to both side surfaces of the multilayer body, respectively. The side margin sheets 54 can be formed by the same method as that of the second dielectric green sheets 51b.

### Third Embodiment

In the first and second embodiments, the first dielectric layers 11a containing the low melting point metal are disposed only in the central portion of the multilayer chip 10 in the T direction, but the low melting point metal may be added to all the dielectric layers 11.

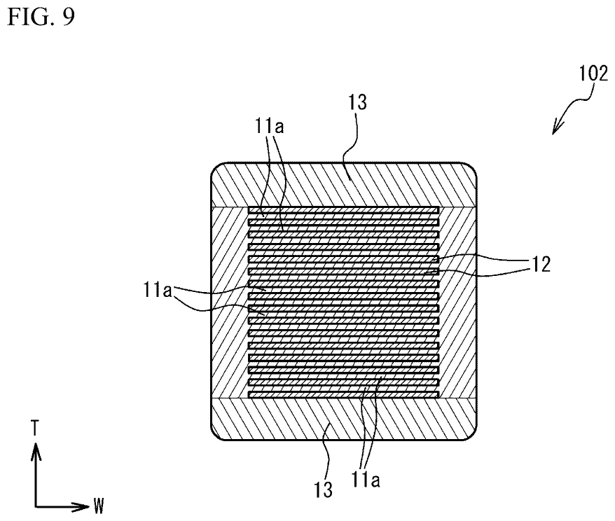

FIG. 9 is a cross-sectional view of a multilayer ceramic capacitor 102 according to a third embodiment. FIG. 9 illustrates a cross section at the same position as the cross section in FIG. 2B.

As illustrated in FIG. 9, in the multilayer ceramic capacitor 102 according to the third embodiment, all of the dielectric layers 11 are the first dielectric layers 11a containing low melting point metal. The other configurations are the same as those of the first embodiment, and thus the detailed description thereof will be omitted.

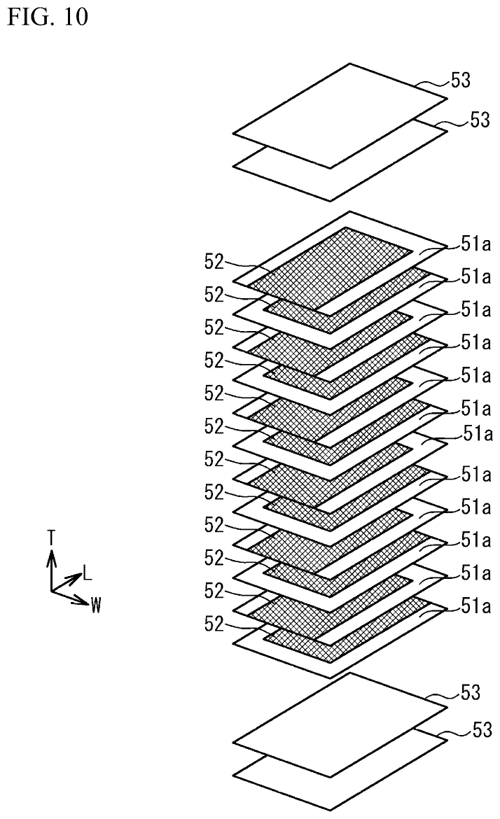

The multilayer ceramic capacitor 102 according to the third embodiment can be produced as illustrated in FIG. 10. First, the internal electrode patterns 52 are formed on the first dielectric green sheets 51a to form multilayer units. Next, the multilayer units are sequentially stacked. Next, the predetermined number (for example, 2 to 10) of cover sheets 53 are stacked on and under the multilayer body obtained by stacking the multilayer units, and are thermally compressed.

As in the third embodiment, the low melting point metal may be added to all the dielectric layers 11, not only to the central portion of the multilayer chip 10 in the T direction. From the viewpoint of suppressing the expansion of the internal electrode layers 12, the number of the first dielectric layers 11a to which the low melting point metal is added is preferably 10% to 50% of the total number of dielectric layers 11 (i.e., the total number of first dielectric layers 11a +the total number of second dielectric layers 11b).

### Fourth Embodiment

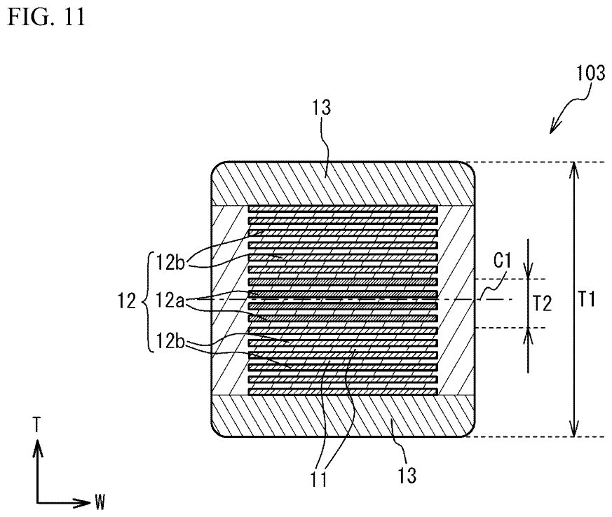

In a fourth embodiment, the low melting point metal is added not to the dielectric layers 11 but to the internal electrode layers 12 in the central portion of the multilayer chip 10 in the T direction. FIG. 11 is a cross-sectional view of a multilayer ceramic capacitor 103 according to a fourth embodiment. FIG. 11 illustrates a cross section at the same position as the cross section in FIG. 2B.

In the fourth embodiment, the internal electrode layers 12 in the central portion of the multilayer chip 10 in the T direction are provided with the low melting point metal. The internal electrode layers 12 containing the low melting point metal are referred to as first internal electrode layers 12a, and the internal electrode layers 12 containing no low melting point metals are referred to as second internal electrode layers 12b. That is, the internal electrode layers 12 include the first internal electrode layers 12a and the second internal electrode layers 12b.

Since the low melting point metal is provided inside the internal electrode layers 12 at least in the central portion of the multilayer chip 10 in the T direction, the decomposition of the binder is promoted and the release of the decomposition gas is improved during the heat treatment in the debinding step, as compared with the case where the low melting point metal is not provided. This realizes the favorable debinding property, and suppresses the cracks and the delamination.

If a sufficient amount of the low melting point metal is not added, there is a possibility that the sufficiently favorable debinding property cannot be obtained. Therefore, it is preferable to set a lower limit to the concentration of the low melting point metal. In the present embodiment, the concentration of the low melting point metals is preferably 0.1 at % or more, more preferably 0.3 at % or more, and further preferably 0.5 at % or more. The concentration of the low melting point metal is an amount (at %) of the low melting point metal in the case where Ni of the internal electrode layers 12 is set to 100 at % in the entirety of one internal electrode layer 12 sandwiched between two adjacent dielectric layers 11. When a plurality of types of low melting point metals are contained, the concentration of the low melting point metal is the total amount of the plurality of types of low melting point metals.

On the other hand, when the additive amount of the low melting point metal is large, the internal electrode may be spheroidized due to oversintering or the abnormal grain growth of the dielectric layer may occur. Therefore, it is preferable to set an upper limit to the concentration of the low melting point metal. In the present embodiment, the concentration of the low melting point metal is preferably 10 at % or less, more preferably 5 at % or less, and further preferably 2 at % or less.

When the internal electrode layers 12 contain the low melting point metal, the low melting point metal may be alloyed with Ni which is the main component of the internal electrode layers 12, or may be disposed as a single metal. For example, the low melting point metal may be disposed so as to be uniformly dispersed in the internal electrode layers 12, or may be segregated at an interface between the internal electrode layer 12 and the dielectric layer 11.

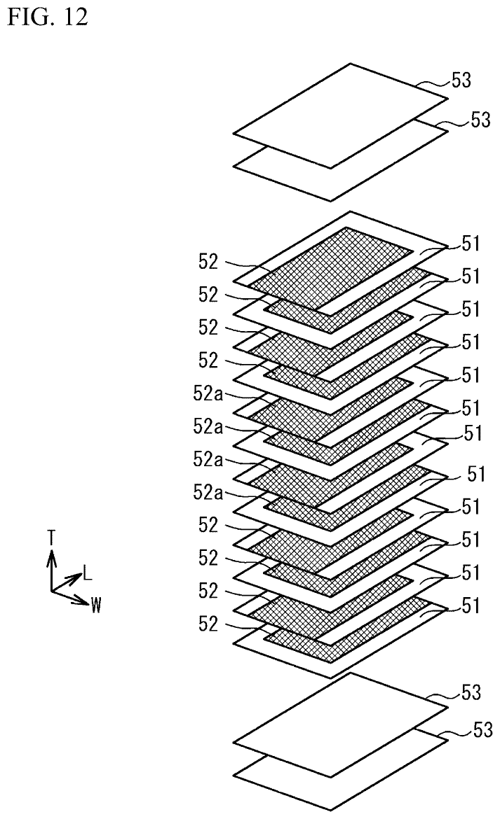

The multilayer ceramic capacitor 103 according to the fourth embodiment can be produced as illustrated in FIG. 12. First, the internal electrode patterns 52 are formed on dielectric green sheets 51 containing no low melting point metal to form the first multilayer units. A metal paste containing Ni powder is used for the internal electrode patterns 52. Next, the first multilayer units are sequentially stacked.

Next, internal electrode patterns 52a are formed on the dielectric green sheets 51 to form the second multilayer units. A metal paste containing Ni powder and a low melting point metal with a melting point of 700° C. or less added thereto is used for the internal electrode patterns 52a.

If a sufficient amount of the low melting point metal is not added, there is a possibility that the sufficiently favorable debinding property cannot be obtained. Therefore, it is preferable to set a lower limit to the concentration of the low melting point metal. In the present embodiment, the concentration of the low melting point metal is preferably 0.1 at % or more, more preferably 0.3 at % or more, and further preferably 0.5 at % or more.

On the other hand, when the additive amount of the low-melting point metal is large, the internal electrode may be spheroidized due to oversintering or the abnormal grain growth of the dielectric layer may occur. Therefore, it is preferable to set an upper limit to the concentration of the low melting point metal. In the present embodiment, the concentration of the low melting point metal is preferably 10 at % or less, more preferably 5 at % or less, and further preferably 2 at % or less.

Next, the multilayer units are sequentially stacked. Next, a predetermined number (for example, 2 to 10) of cover sheets 53 are stacked on and under the multilayer body obtained by stacking the multilayer units, and are thermally compressed.

### Fifth Embodiment

In the fourth embodiment, the first internal electrode layer 12a containing the low melting point metal is disposed only in the central portion of the multilayer chip 10 in the T direction, but the low melting point metal may be added to all the internal electrode layers 12.

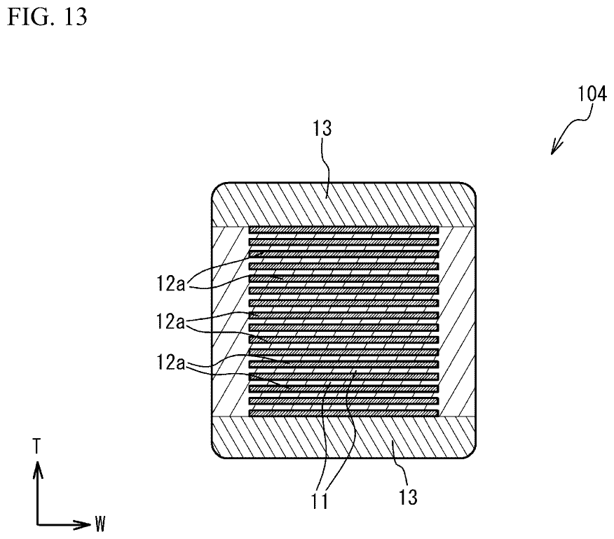

FIG. 13 is a cross-sectional view of a multilayer ceramic capacitor 104 according to a fifth embodiment. FIG. 13 illustrates a cross section at the same position as the cross section in FIG. 2B.

As illustrated in FIG. 13, in the multilayer ceramic capacitor 104 according to the fifth embodiment, all of the internal electrode layers 12 are the first internal electrode layers 12a containing low melting metal. The other configurations are the same as those of the fourth embodiment, and thus the detailed description thereof will be omitted.

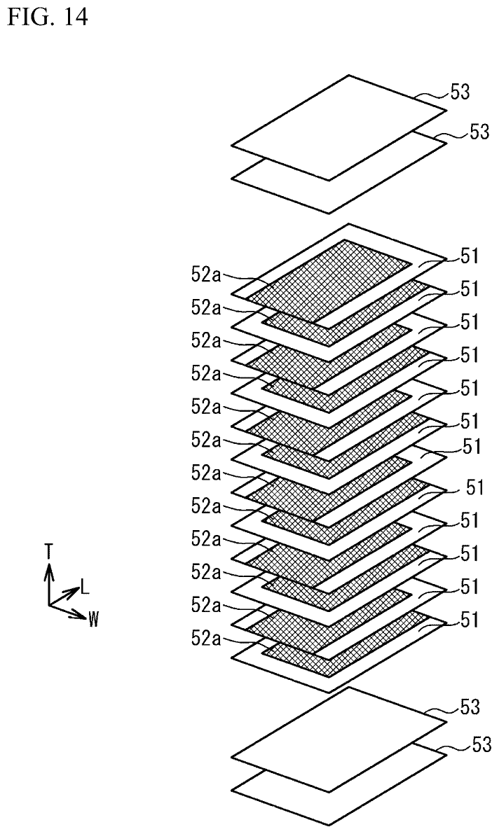

The multilayer ceramic capacitor 104 according to the fifth embodiment can be produced as illustrated in FIG. 14. First, the internal electrode patterns 52a are formed on the dielectric green sheets 51 to form the multilayer units. A metal paste containing Ni powder and a low melting point metal with a melting point of 700° C. or less added thereto is used for the internal electrode patterns 52a.

Next, the multilayer units are sequentially stacked. Next, a predetermined number of (for example, 2 to 10) cover sheets 53 are stacked on and under the multilayer body obtained by stacking the multilayer units, and are thermally compressed.

As in the fifth embodiment, the low melting point metal may be added to all the internal electrode layers 12, not only the central portion of the multilayer chip 10 in the T direction. From the viewpoint of suppressing the expansion of the internal electrode layers 12, the number of first internal electrode layers 12a to which the low melting point metal is added is preferably 10% to 50% of the total number of internal electrode layers 12 (i.e., the total number of first internal electrode layers 12a +the total number of second internal electrode layers 12b).

### Sixth Embodiment

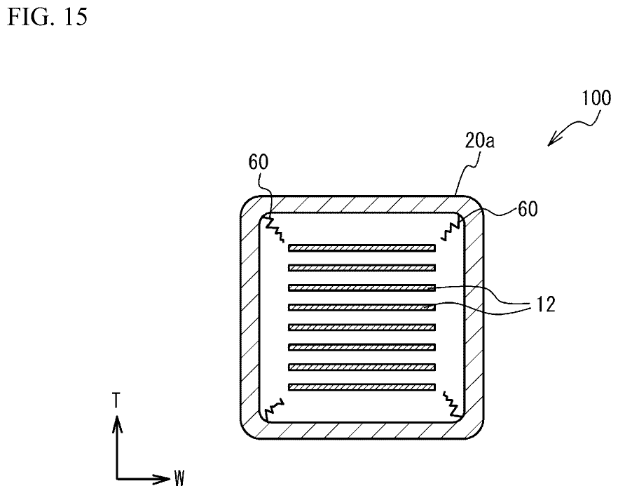

In the cross sections in the W direction and the T direction at the positions of the external electrodes 20a and 20b, when excessive diffusion occurs from the external electrodes 20a and 20b to the internal electrode layers 12, cracks 60 may occur at the corner portions near the external electrodes as illustrated in FIG. 15. In particular, when the main component metal of the base layer 21 is Cu and the main component metal of the internal electrode layers 12 is Ni, the diffusion is likely to occur. In addition, when the low melting point metal as described above is disposed in the dielectric layer 11, in the internal electrode layer 12, or at the interface between the internal electrode layer 12 and the dielectric layer 11, there is a concern that diffusion from the base layer 21 may be promoted when the base layer 21 is formed. Note that FIG. 15 corresponds to a cross section taken along line C-C in FIG. 1B.

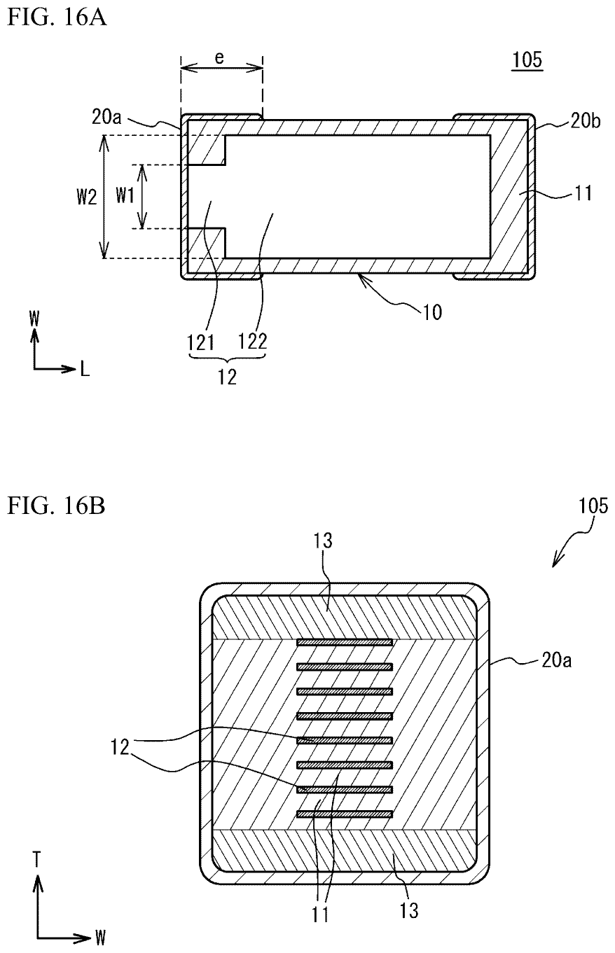

Therefore, in a multilayer ceramic capacitor 105 according to a sixth embodiment, the dimension of each internal electrode layer 12 in the W direction is changed. FIG. 16A is a cross-sectional view illustrating an LW cross section of the multilayer ceramic capacitor 105, and FIG. 16B is a cross-sectional view illustrating a WT cross section of the end margin 15 of the multilayer ceramic capacitor 105. In the sixth embodiment, it is assumed that the low melting point metal is added to all the internal electrode layers 12. As illustrated in FIG. 16A, the internal electrode layer 12 connected to the external electrode 20a includes a first region 121 (connection portion) connected to the external electrode 20a in the region corresponding to the end margin 15 and having a width W1 in the W direction, and a second region 122 having a width W2 in the W direction in the region corresponding to the capacitance portion 14. The W1 is shorter than the W2. In the W direction, the first region 121 is located inside the second region 122. According to this configuration, the contact areas between the external electrodes 20a and 20b and the internal electrode layers 12 are reduced, and thus the diffusion from the external electrodes 20a and 20b to the internal electrode layers 12 is suppressed. This suppresses the occurrence of the cracks 60. The internal electrode layer 12 connected to the external electrode 20b also includes the first region 121 having the width W1 and the second region 122 having the width W2.

For example, if W1/W2 is small, the connectivity between the external electrodes 20a and 20b and the internal electrode layers 12 may decrease, and favorable conduction may not be obtained. Therefore, it is preferable to set a lower limit for the W1/W2. On the other hand, if the W1/W2 is large, there is a possibility that the contact areas between the external electrodes 20a and 20b and the internal electrode layers 12 cannot be sufficiently reduced. Therefore, it is preferable to set an upper limit to the W1/W2. From the above, the W1/W2 is preferably ½ or more, and more preferably ⅔ or more. The W1/W2 is preferably ⅘ or less, and more preferably ¾ or less.

Here, as illustrated in FIG. 16A, the dimensions of the external electrodes 20a and 20b extending in the L direction from both end surfaces of the multilayer chip 10 are referred to as dimensions “e”. From the viewpoint of suppressing the cracks 60 in the corner portions, the dimension of the first region 121 in the L direction is preferably equal to or greater than ⅓ of the dimension “e”, and more preferably equal to or greater than ½ of the dimension “e”.

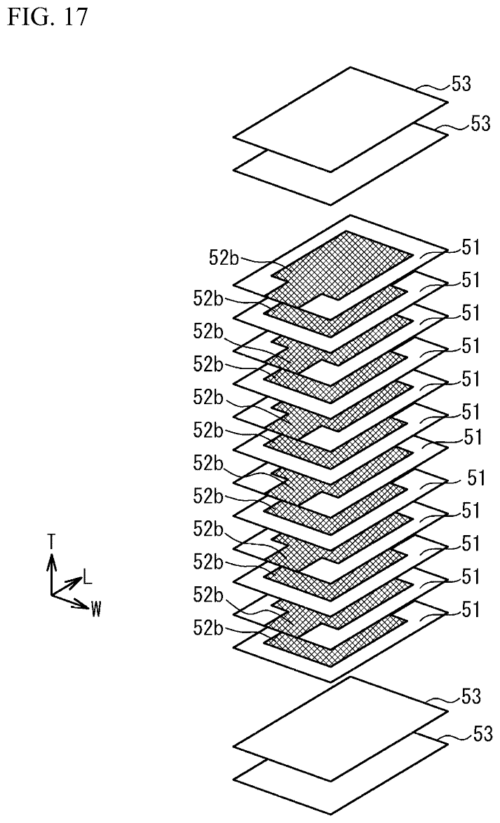

The multilayer ceramic capacitor 105 according to the sixth embodiment can be produced as illustrated in FIG. 17. First, internal electrode patterns 52b having the widths W1 and W2 are formed on the dielectric green sheets 51 to form the multilayer units. A metal paste containing Ni powder and a low melting point metal with a melting point of 700° C. or less added thereto is used for the internal electrode patterns 52b.

Next, the multilayer units are sequentially stacked. Next, a predetermined number (for example, 2 to 10) of cover sheets 53 are stacked on and under the multilayer body obtained by stacking the multilayer units, and are thermally compressed.

In the sixth embodiment, the low melting metal may be added only to the internal electrode layers 12 in the central portion of the multilayer chip 10 in the T direction. Alternatively, the low melting point metal may be added to the dielectric layers 11, not to the internal electrode layers 12.

Although all the internal electrode layers 12 have the first regions 121 and the second regions 122 in the sixth embodiment, it is sufficient that one or more internal electrode layers 12 from the outermost layer have the first regions 121 and the second regions 122.

From the viewpoint of suppressing diffusion from the external electrodes 20a and 20b to the internal electrode layers 12, the internal electrode layers 12 having the first regions 121 and the second regions 122 preferably account for 10% or more of the total number of internal electrode layers 12, and the internal electrode layers 12 having the first regions 121 and the second regions 122 more preferably account for 25% or more of the total number of internal electrode layers 12. On the other hand, from the viewpoint of reducing the connection failures between the external electrodes 20a and 20b and the internal electrode layers 12, the internal electrode layers 12 having the first regions 121 and the second regions 122 preferably account for 50% or less of the total number of internal electrode layers 12, and the internal electrode layers 12 having the first regions 121 and the second regions 122 more preferably account for 40% or less of the total number of internal electrode layers 12.

In the first to sixth embodiments, the low melting point metal is added to the dielectric layer 11 or the internal electrode layer 12 at least in the central portion of the multilayer chip 10 in the T direction, but the present disclosure is not limited thereto. The low melting point metal may be provided in at least one of the inside of the internal electrode layers 12, the inside of the dielectric layers 11, and the interface between the internal electrode layer 12 and the dielectric layer 11.

In each of the above-described embodiments, the multilayer ceramic capacitor has been described as an example of a ceramic electronic component, but the present disclosure is not limited thereto. For example, the configurations of the above-described embodiments are applicable to other multilayer ceramic electronic components such as varistors and thermistors.

### Examples

Hereinafter, the multilayer ceramic capacitor according to each embodiment was produced, and the characteristics thereof were examined.

### First Example

In a first example, the multilayer ceramic capacitor described in the first embodiment was produced. First, a slurry containing BaTiO₃ as a main component was mixed and applied to obtain a second dielectric green sheet. An internal electrode pattern was printed on each second dielectric green sheet to obtain a second multilayer unit. Nickel powders were used for the internal electrode pattern.

A slurry containing BaTiO₃ as a main component and Sn was mixed and applied to obtain a first dielectric green sheet. The internal electrode pattern was printed on each first dielectric green sheet to obtain a first multilayer unit. The concentration of Sn was 1.5 at %.

After 350 layers of the second multilayer unit were stacked, 100 layers of the first multilayer unit were stacked, and 350 layers of the second multilayer unit were stacked again to obtain a multilayer body.

A slurry containing BaTiO₃ as a main component was mixed and applied to obtain a cover sheet. A plurality of cover sheets were stacked on and pressure-bonded to each of the upper and lower sides of the multilayer body in the stacking direction, and then barrel polishing was performed, and a debinding step was performed. Thereafter, the resultant was fired and subjected to reoxidation treatment. A metal paste containing Cu as a main component was applied to two end surfaces of the obtained multilayer chip, and baked at about 800° C. Through these steps, a multilayer ceramic capacitor was produced in which 800 internal electrodes were stacked, and which had a length L0 of 2.0 mm, a width W0 of 1.25 mm, and a height T0 of 1.25 mm.

In the fired multilayer ceramic capacitor, the thickness of each internal electrode layer in the T direction was 0.7 μm, and the thickness of each dielectric layer in the T direction was 0.7 μm. The thickness of each cover layer in the T direction was 60 μm. The widths (W1=W2) of the internal electrodes in the W direction were 1.15 mm. The dimension “e” of the outer electrodes was 0.5 mm.

### Second Example

In a second example, the multilayer ceramic capacitor described in the second embodiment was produced. First, a slurry containing BaTiO₃ as a main component was mixed and applied to obtain a second dielectric green sheet. An internal electrode pattern was printed on each second dielectric green sheet to obtain a second multilayer unit. The width of the internal electrode pattern in the W direction was made to coincide with the width of the second dielectric green sheet in the W direction. Nickel powders were used for the internal electrode pattern.

A slurry containing BaTiO₃ as a main component and Sn was mixed and applied to obtain a first dielectric green sheet. An internal electrode pattern was printed on each first dielectric green sheet to obtain a first multilayer unit. The width of the internal electrode pattern in the W direction was made to coincide with the width of the first dielectric green sheet in the W direction. The concentration of Sn was 1.5 at %.

After 350 layers of the second multilayer unit were stacked, 100 layers of the first multilayer unit were stacked, and 350 layers of the second multilayer unit were stacked again to obtain a multilayer body.

A slurry containing BaTiO₃ as a main component was mixed and applied to obtain a cover sheet. A plurality of cover sheets were stacked on and pressure-bonded to each of the upper and lower sides of the multilayer body in the stacking direction.

A slurry containing BaTiO₃ as a main component was mixed and applied to obtain a side margin sheet. The Sn concentration of the side margin sheet was expressed as 0 at %. A plurality of side margin sheets were attached to both ends of the multilayer body in the W direction. Thereafter, barrel polishing was performed, and a debinding step was performed. The other conditions were the same as those in the first example. Note that the Sn concentration of the side margin sheet is an amount (at %) of Sn in the entire side margin sheet when the B site element of the side margin sheet is represented by 100 at %.

### Third Example

In a third example, the multilayer ceramic capacitor described in the fourth embodiment was produced. First, a slurry containing BaTiO₃ as a main component was mixed and applied to obtain a dielectric green sheet. A second internal electrode pattern was printed on each dielectric green sheet to obtain a second multilayer unit. Nickel powders were used for the second internal electrode pattern.

In addition, a first internal electrode pattern was printed on each dielectric green sheet to obtain a first multilayer unit. For the first internal electrode pattern, nickel powders to which Sn was added were used. The concentration of Sn was 1.5 at %.

After 350 layers of the second multilayer unit were stacked, 100 layers of the first multilayer unit were stacked, and 350 layers of the second multilayer unit were stacked again to obtain a multilayer body. The other conditions were the same as those in the first example.

### Fourth Example

In a fourth example, the multilayer ceramic capacitor described in the fifth embodiment was produced. First, a slurry containing BaTiO₃ as a main component was mixed and applied to obtain a dielectric green sheet. An internal electrode pattern was printed on each dielectric green sheet to obtain a multilayer unit. For the internal electrode pattern, nickel powders to which Sn was added were used. The concentration of Sn was 1.5 at %.

A multilayer body was obtained by stacking 800 layers of the multilayer unit. The other conditions were the same as those in the first example.

### Fifth Example

In a fifth example, the multilayer ceramic capacitor described in the sixth embodiment was produced. First, a slurry containing BaTiO₃ as a main component was mixed and applied to obtain a dielectric green sheet. In each internal electrode pattern, the width W2 in the W direction was increased in the capacitance portion, and the width W1 in the W direction was decreased in the end margin. The width W2 of the internal electrode pattern in the capacitance portion was 1.15 mm, and the width W1 of the internal electrode pattern in the end margin was 1.0 mm. The dimension of the first region which has the width W1 in the L direction was set to 0.1 mm. The other conditions were the same as those in the fourth example.

### Comparative Example

In the comparative example, Sn was not added to the dielectric green sheet and the internal electrode pattern. The other conditions were the same as those in the first example.

Table 1 illustrates the conditions of the first to the fifth examples and the comparative example.

TABLE 1

| | INTERNAL ELECTRODE LAYER | | | DIELECTRIC LAYER | | |
|---|---|---|---|---|---|---|
| | ADDITIVE | CONCENTRATION | STACKING | ADDITIVE | CONCENTRATION | STACKING |
| | METAL | (at %) | NUMBER | METAL | (at %) | NUMBER |
| FIRST | — | — | 800 | FIRST: Sn | FIRST: 1.5 | FIRST: 100 |
| EXAMPLE | | | | SECOND: — | SECOND: — | SECOND: EACH 350 |
| SECOND | — | — | 800 | FIRST: Sn | FIRST: 1.5 | FIRST: 100 |
| EXAMPLE | | | | SECOND: — | SECOND: — | SECOND: EACH 350 |
| THIRD | FIRST: Sn | FIRST: 1.5 | FIRST: 100 | — | — | 800 |
| EXAMPLE | SECOND: — | SECOND: — | SECOND: EACH 350 | | | |
| FOURTH | Sn | 1.5 | 800 | — | — | 800 |
| EXAMPLE | | | | | | |
| FIFTH | Sn | 1.5 | 800 | — | — | 800 |
| EXAMPLE | | | | | | |
| COMPARATIVE | — | — | 800 | — | — | 800 |
| EXAMPLE | | | | | | |

| | L0 | W0 | T0 | W1 | W2 |
|---|---|---|---|---|---|
| | (mm) | (mm) | (mm) | (mm) | (mm) |
| FIRST | 2.0 | 1.25 | 1.25 | 1.15 | 1.15 |
| EXAMPLE | | | | | |
| SECOND | 2.0 | 1.25 | 1.25 | 1.15 | 1.15 |
| EXAMPLE | | | | | |
| THIRD | 2.0 | 1.25 | 1.25 | 1.15 | 1.15 |
| EXAMPLE | | | | | |
| FOURTH | 2.0 | 1.25 | 1.25 | 1.15 | 1.15 |
| EXAMPLE | | | | | |
| FIFTH | 2.0 | 1.25 | 1.25 | 1.0 | 1.15 |
| EXAMPLE | | | | | |
| COMPARATIVE | 2.0 | 1.25 | 1.25 | 1.15 | 1.15 |
| EXAMPLE | | | | | |

For each of the comparative example and the first to the fourth examples, 100 samples were prepared, and the W-T cross section at the center in the L direction was observed. In the comparative example, cracks and delamination were confirmed in the inside of half or more of the samples. In the first to the fourth examples, no crack or delamination was confirmed. This is considered to be because the decomposition of the binder and the escape of the decomposition gas during the debinding were improved and the occurrence of the cracks and the delamination was suppressed by disposing the low melting point metal in the dielectric layer or the internal electrode layer near the center in the T direction of the multilayer chip where problems are likely to occur during the debinding.

In addition, 100 samples were prepared for each of the first to the fifth examples, and the W-T cross section (cross section taken along line C-C in FIG. 1B) in the end margin was observed. In the first to the third examples, the number of samples in which the cracks were confirmed in the corner portions was five or less, but in the fourth example, the cracks were confirmed in the corner portions in half or more of the samples. In the fifth example, no crack was confirmed in the corner portions.

This is considered to be because the diffusion of Cu from the external electrode is promoted by the low melting point metal such as Sn, but in the first to the third examples in which the number of portions having Sn is smaller than that in the fourth example in the internal electrode layer and the interface between the internal electrode layer and the dielectric layer, the expansion of the internal electrode layer is suppressed, and thus the cracks in the corner portions are suppressed more than those in the fourth example.

In addition, in the fifth example, it is considered that the contact surface between the external electrode and the internal electrode layer was reduced to suppress the diffusion of Cu from the external electrode, and the distance between the external electrode and the internal electrode layer was increased at the corner portions, so that the expansion of the internal electrode layer was relaxed and the cracks at the corner portions were suppressed.

Although the embodiments of the present disclosure are described in detail above, the present disclosure is not limited to the specific embodiments. It is to be understood that the various change, substitutions, and alterations could be made hereto without departing from the spirit and scope of the invention.

What is claimed is:

1. A ceramic electronic component having a dimension in a first direction, a dimension in a second direction orthogonal to the first direction, and a dimension in a third direction orthogonal to the first direction and the second direction that are all 1 mm or greater, the ceramic electronic component comprising:
a multilayer chip including a plurality of dielectric layers and a plurality of internal electrode layers including metal as a main component,
the plurality of dielectric layers and the plurality of internal electrode layers being alternately stacked in the third direction, the multilayer chip having a substantially rectangular parallelepiped shape and being formed so that the plurality of internal electrode layers are alternately exposed on a first end surface and a second end surface facing each other in the second direction,
wherein a stacking number of internal electrode layers per unit height in a section where adjacent internal electrode layers connected to different external electrodes face each other is 700 layers/mm or greater, and
wherein a metal component having a melting point of 700° C. or less is provided in at least one of the following locations: inside at least a first internal electrode layer disposed in a central portion of the multilayer chip in the third direction in the plurality of internal electrode layers, inside at least a first dielectric layer disposed in the central portion in the plurality of dielectric layers, and at an interface between the first internal electrode layer and the first dielectric layer.

2. The ceramic electronic component according to claim 1, wherein the metal component contains any one of Sn, Bi, Cd, Pb, Zn, Sb, and Al.

3. The ceramic electronic component according to claim 2, wherein the metal component is Sn.

4. The ceramic electronic component according to claim 1,
wherein a concentration of the metal component inside the first internal electrode layer is higher than a concentration of the metal component inside a second internal electrode layer other than the first internal electrode layer in the plurality of internal electrode layers,
wherein a concentration of the metal component inside the first dielectric layer is higher than a concentration of the metal component inside a second dielectric layer other than the first dielectric layer in the plurality of dielectric layers, and
wherein a concentration of the metal component at the interface between the first internal electrode layer and the first dielectric layer is higher than a concentration of the metal component at an interface between the second internal electrode layer and the second dielectric layer.

5. The ceramic electronic component according to claim 1, wherein a concentration of the metal component in at least one of the following locations: inside the first internal electrode layer, inside the first dielectric layer, and at the interface between the first internal electrode layer and the first dielectric layer is 0.5 at % to 3 at %.

6. The ceramic electronic component according to claim 4,
wherein a number of internal electrode layers containing the metal component in the plurality of internal electrode layers is 10% to 50% of a total number of the plurality of internal electrode layers, and
wherein a number of dielectric layers containing the metal component in the plurality of dielectric layers is 10% to 50% of a total number of the plurality of dielectric layers.

7. The ceramic electronic component according to claim 1, further comprising:
a pair of external electrodes provided on the first end surface and the second end surface, the pair of external electrodes each including a base layer including Cu as a main component and a plating layer formed on the base layer;
wherein the plurality of internal electrode layers contain Ni as a main component, and
wherein in one or more internal electrode layers from an outermost layer in the plurality of internal electrode layers, a width of a connection portion in the first direction connected to the external electrode is narrower than a width of another region.

8. The ceramic electronic component according to claim 7,
wherein the width of the connection portion in the first direction is ½ or more and ⅘ or less of widths of the internal electrode layers in the first direction in a section where the internal electrode layers connected to different external electrodes face each other.

9. The ceramic electronic component according to claim 1, further comprising:
a pair of external electrodes provided on the first end surface and the second end surface, the pair of external electrodes each including a base layer including Cu as a main component and a plating layer formed on the base layer;
wherein the plurality of internal electrode layers contain Ni as a main component, and
wherein in each of the plurality of internal electrode layers, a width of a connection portion connected to a corresponding one of the pair of external electrodes in the first direction is narrower than a width of another region.

10. The ceramic electronic component according to claim 9,
wherein the width of the connection portion in the first direction is ½ or more and ⅘ or less of widths of the internal electrode layers in the first direction in a section where the internal electrode layers connected to different external electrodes face each other.

11. A method of manufacturing a ceramic electronic component, the ceramic electronic component having a dimension in a first direction, a dimension in a second direction orthogonal to the first direction, and a dimension in a third direction orthogonal to the first direction and the second direction that are all 1 mm or more, the method comprising:
stacking a plurality of first multilayer units in the third direction to obtain a first multilayer body, each of the first multilayer units including a first dielectric green sheet and a first internal electrode pattern formed on the first dielectric green sheet;
stacking a plurality of second multilayer units on the first multilayer body to obtain a second multilayer body, each of the second multilayer units including a second dielectric green sheet and a second internal electrode pattern formed on the second dielectric green sheet;
stacking a plurality of first multilayer units on the second multilayer body to obtain a third multilayer body; and
firing the third multilayer body;
wherein a stacking number of the first internal electrode pattern and the second internal electrode pattern per unit height of the third multilayer body is 700 layers/mm or greater, and
wherein a metal component having a melting point of 700° C. or less is added to at least the second dielectric green sheet or at least the second internal electrode pattern.
